(19) United States
(12) Patent Application Publication
(10) Pub. No.: US 2026/0119016 A1
(43) Pub. Date: Apr. 30, 2026

(54) INFORMATION INTERACTION

(71) Applicant: Beijing Zitiao Network Technology Co., Ltd., Beijing (CN)

(72) Inventors: Jiahui Yang, Beijing (CN); Yang Wang, Beijing (CN); Jiayi Xu, Beijing (CN); Nuomeng Zhang, Beijing (CN)

(21) Appl. No.: 19/040,460

(22) Filed: Jan. 29, 2025

Related U.S. Application Data
(63) Continuation of application No. PCT/CN2024/127921, filed on Oct. 28, 2024.

(51) Int. Cl. G06F 3/0484; G06F 3/04817

(52) U.S. Cl. CPC G06F 3/0484; G06F 3/04817

(57) ABSTRACT

Provided in the present disclosure a method, apparatus, device, and computer-readable storage medium for information interaction. The method provide includes: presenting a viewing interface of target media content, the target media content comprising a set of foreground elements overlaid on a background image; and in response to a first operation on a first element in the set of foreground elements, presenting a first interactive interface associated with the first element, the first interactive interface being configured to: present a first set of interaction information associated with the first element. In this manner, the embodiments in the present disclosure can present an interactive interface corresponding to each set of foreground elements in the target media content, thereby improving the presentation efficiency of the interaction information.

### CROSS-REFERENCE

The present application claims priority to PCT Patent Application PCT/CN2024/127921, filed on Oct. 28, 2024, entitled “Method, Apparatus, Device and Storage Medium for Information Interaction”, the entirety of which is incorporated herein by reference

### FIELD

Example embodiments in the present disclosure generally relate to the field of computers, and in particular, to a method, apparatus, device, and computer-readable storage medium for information interaction.

### BACKGROUND

In recent years, with the development of the Internet, more and more people publish media content on online platforms. For example, users may publish media content aggregated with multiple elements on online platforms. However, based on existing online platforms, users can only interact with the media content as a whole, and cannot interact with individual elements in the media content.

### SUMMARY

In a first aspect in the present disclosure, a method for information interaction is provided, including: presenting a viewing interface of target media content, the target media content including a set of foreground elements overlaid on a background image; and in response to a first operation on a first element in the set of foreground elements, presenting a first interactive interface associated with the first element, the first interactive interface being configured to: present a first set of interaction information associated with the first element.

In a second aspect in the present disclosure, an apparatus for information interaction is provided. The apparatus includes: a first presenting module, presenting a viewing interface of target media content, the target media content including a set of foreground elements overlaid on a background image; and a second presenting module, configured to present, in response to a first operation on a first element in the set of foreground elements, a first interactive interface associated with the first element, the first interactive interface being configured to: present a first set of interaction information associated with the first element.

In a third aspect in the present disclosure, an electronic device is provided. The device includes at least one processing unit; and at least one memory coupled to the at least one processing unit and storing instructions executed by the at least one processing unit, the instructions, when executed by the at least one processing unit, causing the electronic device to perform the method of any of the first aspect.

In a fourth aspect in the present disclosure, a computer-readable storage medium is provided. The computer-readable storage medium have stored thereon a computer program which, executable by a processor to perform the method of any of the first aspect.

It should be understood that the content described in this summary is not intended to limit the key features or important features of the embodiments in the present disclosure, nor is it intended to limit the scope of the present disclosure. Other features in the present disclosure will become readily understood from the following description.

### BRIEF DESCRIPTION OF DRAWINGS

The above and other features, advantages, and aspects of various embodiments in the present disclosure will become more apparent from the following detailed description taken in combination with the accompanying drawings. In the drawings, the same or similar reference numbers refer to the same or similar elements, wherein:

FIG. 1 illustrates a schematic diagram of an example environment in which some embodiments in the present disclosure may be implemented;

FIGS. 2A-2E illustrate example interfaces according to some embodiments in the present disclosure;

FIG. 3 illustrates a flowchart of an example process of information interaction according to some embodiments in the present disclosure;

FIG. 4 illustrates a schematic structural block diagram of an example apparatus for information interaction according to some embodiments in the present disclosure; and

FIG. 5 illustrates a block diagram of an electronic device capable of implementing various embodiments in the present disclosure.

### DETAILED DESCRIPTION

Embodiments in the present disclosure will be described in more detail below with reference to the accompanying drawings. Although certain embodiments in the present disclosure are shown in the drawings, it would be appreciated that the present disclosure can be implemented in various forms and should not be interpreted as limited to the embodiments described in this specification. On the contrary, these embodiments are provided for a more thorough and complete understanding of the present disclosure. It would be appreciated that the accompanying drawings and embodiments in the present disclosure are only for the purpose of illustration and are not intended to limit the scope of protection of the present disclosure.

It should be noted that the headline of any section/subsection provided in the specification is not limiting. Various embodiments are described throughout the specification and any type of embodiments may be included in any section/subsection. Furthermore, the embodiments described in any section/subsection may be combined in any manner with any other embodiment described in the same section/subsection and/or different sections/subsections.

In the description of the embodiments in the present disclosure, the term “including” and similar terms would be appreciated as open-ended inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. The terms “first,” “second,” and the like may refer to different or the same object. Other explicit and implicit definitions may also be included below.

The embodiments in the present disclosure may relate to user data, acquisition and/or use of data, and the like. These aspects shall comply with the requirements of corresponding laws, regulations and relevant provisions. In the embodiments in the present disclosure, the collection, acquisition, processing, manufacturing, forwarding, use of all data and the like are carried out with user's knowledge and consent. Accordingly, in the implementation of the embodiments in the present disclosure, users should be informed of the type, the scope of use, the use scenario, etc., of the involved data or information in an appropriate manner and provide authorization in accordance with relevant laws and regulations. The specific ways of being informed and providing authorization may vary according to actual circumstances and application scenarios, and the scope of this disclosure is not limited in this regard.

In the solutions and embodiments in this disclosure, if personal information processing is involved, it will be carried out based on legitimate grounds (such as obtaining consent from the data subject, or as required to fulfill a contract, etc.) and will be performed only within a specified or agreed scope. If users decline the processing of personal information beyond what is essential for basic functionalities, their utilization of these basic features remains uninterrupted.

As briefly mentioned above, in recent years, with the development of the Internet, more and more people publish media content on online platforms. For example, users may publish media content that aggregates multiple elements on online platforms. However, based on existing online platforms, users can only interact with the media content as a whole, and cannot interact with the elements in the media content individually, thereby failing to meet interactive requirements of the user.

The embodiments in the present disclosure provide a solution for information interaction. According to the solution, a viewing interface of target media content may be presented, the target media content including a set of foreground elements overlaid on a background image; and in response to a first operation on a first element in the set of foreground elements, presenting a first interactive interface associated with the first element, the first interactive interface being configured to: present a first set of interaction information associated with the first element.

In this manner, the embodiments in the present disclosure may present an interactive interface associated with an element in a viewing interface of media content based on an operation on the element in the media content. Therefore, the present disclosure may present, in the interactive interface associated with the element, the interaction information associated with the element, or receive, in the interactive interface, the interactive operation associated with the element. In this manner, the embodiments in the present disclosure may provide users with the interaction information of individual element in the media content, and support users' interactive operation on individual element, thereby meeting users' interactive requirements, enriching the display information of the media content, and improving the display efficiency of the information.

Various example implementations of this solution are described in detail below in combination with the accompanying drawings.

### Example Environment

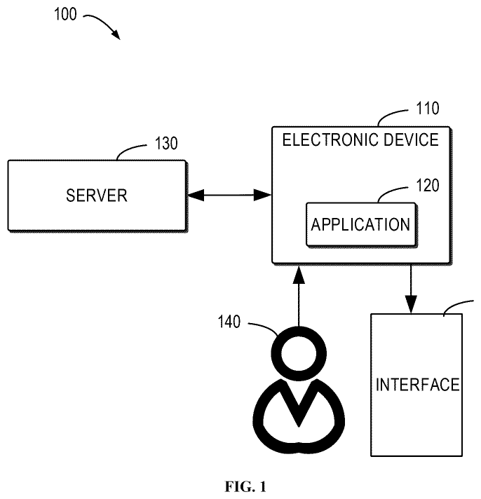

FIG. 1 illustrates a schematic diagram of an example environment 100 in which embodiments in the present disclosure may be implemented. As shown in FIG. 1, the example environment 100 may include an electronic device 110.

In the example environment 100, the electronic device 110 may run an application 120 supporting interface interaction. The application 120 may be an application for interface interaction of any suitable type, examples of which may include, but are not limited to: a video application, a social application, or other suitable application. A user 140 may interact with the application 120 via the electronic device 110 and/or its attached device.

In the environment 100 of FIG. 1, if the application 120 is active, the electronic device 110 may present, via the application 120, an interface 150 for supporting interface interaction.

In some embodiments, the electronic device 110 communicates with a server 130 to carry out the provision of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for the user (such as a “wearable” circuit, etc.).

The server 130 may be a standalone physical server, a server cluster or a distributed system composed of multiple physical servers, or may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for the application 120 supporting interface interaction in the electronic device 110.

A communication connection may be established between the server 130 and the electronic device 110. The communication connection may be established in a wired or wireless manner. The communication connection may include, but is not limited to, a Bluetooth connection, a mobile network connection, a Universal Serial Bus (USB) connection, a Wireless Fidelity (Wi-Fi) connection, and the like, and the embodiments in the present disclosure are not limited in this aspect. In the embodiments in the present disclosure, the server 130 and the electronic device 110 may implement signaling interaction through the communication connection between the server 130 and the electronic device 110.

It should be understood that the structure and function of the various elements in the environment 100 are described for example purposes only and do not imply any limitation on the scope of the present disclosure.

Some example embodiments in the present disclosure will continue to be described below with reference to the accompanying drawings.

### Example Interaction

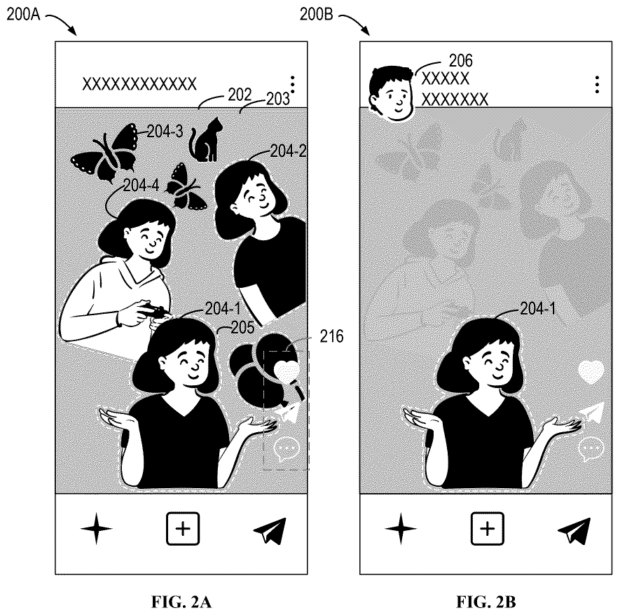

FIGS. 2A-2E illustrate example interfaces 200A-200E according to some embodiments in the present disclosure. The interface 200A-200E may be provided, for example, by the electronic device 110 shown in FIG. 1.

In some embodiments, as shown in FIG. 2A, the electronic device 110 may present a viewing interface 200A of target media content. The electronic device 110 may present the target media content 202 in the viewing interface 200A. As an example, the target media content 202 may be a work posted by a user. Such work may include, for example, image content and music content.

As an example, the target media content 202 may include, for example, a background image 203. For example, the background image 203 may be a solid color background (e.g., a solid gray background) or a background containing a pattern.

As an example, the target media content 202 includes a set of foreground elements overlaid on the background image 203. As an example, as shown in FIG. 2A, the set of foreground elements may include, for example, element 204-1, element 204-2, element 204-3, and element 204-4.

Alternatively, or additionally, the electronic device 110 may present, in the viewing interface 200A, a set of outline elements indicating boundaries of the set of foreground elements. As an example, the electronic device 110 may present an outline element 205 indicating a boundary of the element 204-1. For example, the outline element 205 may be implemented as a dashed line element, a solid line element, or other suitable elements. In this manner, the present disclosure may clearly indicate a plurality of elements contained in the media content based on the outline elements, thereby facilitating viewing and interaction of the plurality of elements by the user.

In some embodiments, the user posting the target media content 202 may be referred to as a poster. Furthermore, the set of foreground elements in the target media content 202 may correspond to a plurality of creators. That is, the creation of the target media content 202 may be completed based on the plurality of creators adding or modifying foreground elements on the background image. For example, the creator of the foreground element may be different from the poster who posted the target media content 202. For example, the creator of element 204-1 may be different from the poster corresponding to the target media content 202. For example, the creator of element 204-2 may be identical to the poster corresponding to the target media content 202.

In some embodiments, as shown in FIG. 2B, the electronic device 110 may present, in response to receiving a second operation (e.g., a single click, etc.) on a first element (e.g., the element 204-1) in the viewing interface 200B, descriptive information 206 of the creator corresponding to the first element (e.g., the element 204-1) in the viewing interface 200B. As an example, the descriptive information 206 may include, for example, a profile picture identifier and/or a text identifier of the creator corresponding to the first element (for example, the name of the creator and/or the description of the creator).

In some embodiments, in response to receiving the second operation on the first element (e.g., element 204-1), the electronic device 110 may, in the viewing interface 200B, adjust a display style (e.g., bolding the edge of the display element 204-1, adjusting the color of the element 204-1, etc.) of the first element (e.g., the element 204-1), and/or adjust the display style of other elements in the set of foreground elements (e.g., reducing the transparency of other elements, adjusting the color of other elements, etc.). In this manner, based on the adjustment of the display style of the first element or other elements in the set of foreground elements, the display priority of the first element may be higher than those of other elements, thereby facilitating viewing or interaction of the first element by the user.

In some embodiments, the electronic device 110 may present, in response to a first operation on the first element in the set of foreground elements, a first interactive interface associated with the first element.

Optionally, as shown in FIG. 2A, the electronic device 110 may present, in response to the first operation (for example, a single-click, a double-click, or a long-press, etc.) on the first element (for example, the element 204-1) in the set of foreground elements, the first interactive interface associated with the first element.

Optionally, continuing with reference to FIG. 2B, the electronic device 110 may present, in response to the first operation (e.g., a single-click, a double-click operation, or a long-press, etc.) on the first element (e.g., the element 204-1), the first interactive interface associated with the first element.

In some embodiments, as shown in FIG. 2C, the electronic device 110 may present a first interactive interface 200C associated with the first element.

As an example, the electronic device 110 may present, in the first interactive interface 200C, a first set of interaction information 208 associated with the first element. As an example, the first set of interaction information 208 may include, but is not limited to, comment information (for example, a timestamp for a comment, image content or text content of a comment, etc.), sharing information, gift interaction information, reposting information, collecting information (for example, the number of collections), like information (for example, users who like the element and the number of the users), and the like.

In some embodiments, continuing with reference to FIG. 2A, the target media content 202 may be associated with a third set of interaction information. As an example, the third set of interaction information may be independent of the first set of interaction information. As an example, the third set of interaction information may include comment information (for example, the number of comments, image content or text content of a comment, etc.), sharing information, gift interaction information, reposting information, collecting information (for example, the number of collections), like information (for example, users who like the target media content 202 and the number of the users), and the like, for the target media content as an entire work.

For example, the electronic device 110 may present, in the viewing interface 200A, a set of interactive controls 216 (e.g., like controls, sharing controls, and comment controls, etc.) associated with the third set of interaction information. For example, the electronic device 110 may present, in the set of interactive controls 216, at least a part of content (for example, the number of likes, the number of shares, the number of comments, etc.) in the third set of interaction information. Further, the electronic device 110 may present, in response to triggering a target interactive control in the set of interactive controls 216, the interaction information associated with the target interactive control.

In some embodiments, continuing with reference to FIG. 2C, the electronic device 110 may receive, in the first interactive interface 200C, the interactive operation associated with the first element (e.g., the element 204-1).

As an example, the electronic device 110 may determine, based on an association relationship between the current user and the creator corresponding to the first element, whether to allow the current user to perform the interactive operation associated with the first element.

For example, the electronic device 110 may determine, in response to the association relationship between the current user and the creator corresponding to the first element meeting a predetermined condition (for example, a friend relationship or a following relationship), that the current user is allowed to perform the interactive operation associated with the first element.

For example, the electronic device 110 may determine, in response to the association relationship between the current user and the creator corresponding to the first element not meeting the predetermined condition (for example, a non-friend relationship or the current user not following the creator, etc.), that the current user is not supported to perform the interactive operation associated with the first element. Further, the electronic device 110 may determine, in response to the relationship between the current user and the creator corresponding to the first element adjusted to meet the pre determined condition (for example, the current user follows the creator, or the current user establishes the friend relationship with the creator), that the current user is allowed to perform the interactive operation associated with the first element.

Additionally, or alternatively, the interactive operation associated with the first element includes a sharing operation. The electronic device 110 may receive the sharing operation associated with the first element and send first content associated with the first element to the target user to be shared with. As an example, the electronic device 110 may provide the sharing control (not shown in the figure) in the first interactive interface 200C. Further, the electronic device 110 may present, in response to triggering the sharing control, a set of predetermined users (for example, a user followed by the current user or a friend of the current user, etc.). Further, the electronic device 110 may send, based on at least one user to be shared with selected from the set of predetermined users by the user, the first content associated with the first element to the at least one user to be shared with. As an example, the first content associated with the first element may include, for example, image content generated based on the first element, descriptive content associated with the first element, predetermined text content (e.g., “I like this element”), or the like.

Additionally, or alternatively, the interactive operation associated with the first element includes a collecting operation. As an example, the electronic device 110 may add, in response to receiving the collecting operation associated with the first element, the first element to a set of resources associated with the current user. As an example, the electronic device 110 may provide a collecting control (not shown in the figure) in the first interactive interface 200C. Further, the electronic device 110 may add the first element to the set of resources associated with the current user in response to a trigger (e.g., a click) on the collecting control. As an example, the set of resources associated with the current user may include, for example, historical collecting content of the current user. The historical collecting content may include, for example, a plurality of pieces of element content or other image content. For example, the set of resources associated with the current user may be understood as an emoji material library of the current user.

In some embodiments, the electronic device 110 may provide, in the first interactive interface 200C, a predetermined control 212 corresponding to the set of resources associated with the current user. Further, the electronic device 110 may present, in response to a trigger on the predetermined control 212, the set of resources associated with the current user.

In some embodiments, as shown in FIG. 2D, the electronic device 110 may present, in the first interactive interface 200D, a set of resource 218 associated with the current user. As an example, the electronic device 110 may present, in the set of resources 218, the historical collected content of the current user. For example, the historical collected content may include collected content 220-1, collecting content 220-2, and collected content 220-3. Further, the electronic device 110 may present the target collected content in a comment area associated with the first element in the first interactive interface 200D in response to a trigger (for example, a click) on the target collected content (for example, the collected content 220-1) in the historical collected content. For example, in addition to applied in a comment scenario associated with the element, the set of resources 218 may also be triggered and presented in other appropriate scenarios (a chat interface with other users, a comment interface of the target media content, etc.) through corresponding operation manners to send, in the corresponding scenario, the historical collected content in the set of resources 218.

In some embodiments, continuing with reference to FIG. 2C, the electronic device 110 may provide, in the first interactive interface 200C, a set of interactive controls. As an example, the set of interactive controls may include, for example, a comment control, a like control (for example, a control 214), a collecting control, a sharing control, and the like. Further, the electronic device 110 may receive the interactive operation associated with the first element via the set of interactive controls. For example, the electronic device 110 may receive a like associated with the first element in response to a trigger on the like control (e.g., control 214).

In some embodiments, the electronic device 110 may send, in response to receiving the interactive operation associated with the first element, a prompt message associated with the interactive operation to a first user associated with the first element and/or a second user associated with the target media content. As an example, the first user may be the creator of the first element. As an example, the second user may be the creator of the target media content. As an example, the second user may be different from the first user. As an example, the interactive operation may be, for example, a like, and the prompt message may include, for example, text content corresponding to the like (for example, “XX user likes your work”) and/or image content.

In some embodiments, the current user may be, for example, the creator of the first element (e.g., the element 204-1). The electronic device 110 may present, in the first interactive interface 200C of the first element, a set of predetermined controls in response to the current user being the creator of the first element. As an example, the set of predetermined controls may include, for example, a deleting control associated with the target comment content. The electronic device 110 may delete the target comment content in response to a trigger on the deleting control by the current user. As an example, the set of predetermined controls may include, for example, a display control associated with like information. The electronic device 110 may adjust a display state (for example, a display state or hidden state) of the like information in the first interactive interface, in response to a trigger on the display control. For example, the description of the set of predetermined controls herein is merely an example, and the set of predetermined controls may further include other controls (for example, a comment pin control, a comment display quantity setting control), and the like. Therefore, the embodiments in the present disclosure may meet the requirements of the creator to manage the display information in the interactive interface.

In some embodiments, continuing with reference to FIG. 2C, the electronic device 110 may present, in the first interactive interface 200C, a first thumbnail 210 of the first element (e.g., the element 204-1). As an example, the first thumbnail 210 may include only the first element. For example, the first thumbnail 210 may further include other elements in the set of foreground elements whose transparency is reduced in the target media content.

As an example, the electronic device 110 may present, in response to the predetermined operation associated with the first thumbnail 210, a second interactive interface associated with a second element in the set of foreground elements. As an example, the predetermined operation may include, for example, a sliding operation on the first thumbnail 210. The second element may be determined based on a sliding direction of the sliding operation. As an example, the electronic device 110 may determine, based on the sliding direction, an element of the set of foreground elements associated with a relative position of the first element in sliding direction. For example, if the sliding direction is the direction indicated by an indication element 211 (e.g., an arrow element), the electronic device 110 may determine that the second element is the element 204-2 based on the direction. In this manner, the embodiments in the present disclosure may quickly switch, based on the operation of the user, the interactive interface corresponding to different foreground elements in the target media content, thereby improving the interaction efficiency and the display efficiency of the content, and meeting the interactive requirement of the user.

In an embodiment, as shown in FIG. 2E, the electronic device 110 may present a second interactive interface 200E. The electronic device 110 may present, in the second interactive interface 200E, a second thumbnail 222 of the second element (e.g., the element 204-2). As an example, the second thumbnail 222 may include only the second element. For example, the first thumbnail 222 may further include other elements in the set of foreground elements whose transparency is reduced in the target media content.

As an example, the electronic device 110 may present, in the second interactive interface 200E, a second set of interaction information 224 associated with the second element. As an example, the second set of interaction information 224 may include, but is not limited to: comment information (for example, a timestamp of a comment, image content or text content of the comment, etc.), sharing information, gift interaction information, reposting information, collecting information (for example, the number of collecting), like information (for example, users who like the element and the number of the users), and the like.

Alternatively, or additionally, the electronic device 110 may also receive, in the second interactive interface 200E, the interactive operation associated with the second element. As an example, the process of the electronic device 110 receiving the interactive operation associated with the second element may refer to the foregoing description of the process of the electronic device 110 receiving the interactive operation associated with the first element, and details would not be described herein again.

Based on the process described above, the embodiments in the present disclosure may present, in the viewing interface of media content, the interactive interface associated with the element based on the operation on the element in the media content. Therefore, the present disclosure may present, in the interactive interface associated with the element, the interaction information associated with the element, or receive, in the interactive interface, the interactive operation associated with the element. In this manner, the embodiments in the present disclosure may provide the user with the interaction information of individual element in the media content and support the interactive operation of individual element by the user, thereby meeting the interactive requirement of the user, enriching the display information of the media content, and improving the display efficiency of the information.

In some embodiments, the embodiments in the present disclosure further provide an interaction solution of media content. Specifically, the electronic device 110 may present the first interactive interface associated with a first portion of the work. As an example, the work may include the target media content 202 as described with reference to the above. Alternatively, the work may also include, for example, a set of media content composed of a plurality of images or videos.

Accordingly, the first portion may correspond to the foreground element included in the target media content 202. Alternatively, the first portion may also correspond to a certain picture or video in the set of media content. As another example, the first portion may also correspond to a particular region of the image content or a particular segment of the video content.

Further, the first interactive interface may be particular to the first portion. Specifically, similar to the interactive interface described above with respect to the first element, the first interactive interface corresponding to the first portion may present the first set of interaction information associated with the first portion. Additionally, or alternatively, the first interactive interface may also receive the interactive operation associated with the first portion.

As an example, the first interactive interface may have an interface style as described with reference to FIG. 2C. For example, the first interactive interface may display the first thumbnail associated with the first portion.

Further, the electronic device 110 may further receive the predetermined operation associated with the first interactive interface. For example, the electronic device 110 may receive the sliding operation associated with the first thumbnail. Further, the electronic device 110 may switch to displaying the second interactive interface associated with a second portion of the work in response to receiving the predetermined operation.

Similarly, the second portion may correspond to the foreground element included in the target media content 202. Alternatively, the second portion may also correspond to a certain picture or video in the set of media content. As another example, the second portion may also correspond to the particular region of image content or the particular segment of video content.

Further, the second interactive interface may be particular to the second portion. Specifically, similar to the interactive interface about the second element as described above, the second interactive interface corresponding to the second portion may present the second set of interaction information associated with the second portion. Additionally, or alternatively, the second interactive interface may also receive the interactive operation associated with the second portion.

Additionally, the electronic device 110 may also switch to display the second thumbnail associated with the second portion in response to the sliding operation for the first thumbnail. As an example, the second interactive interface may have the interface style as described with reference to FIG. 2E.

### Example Processes

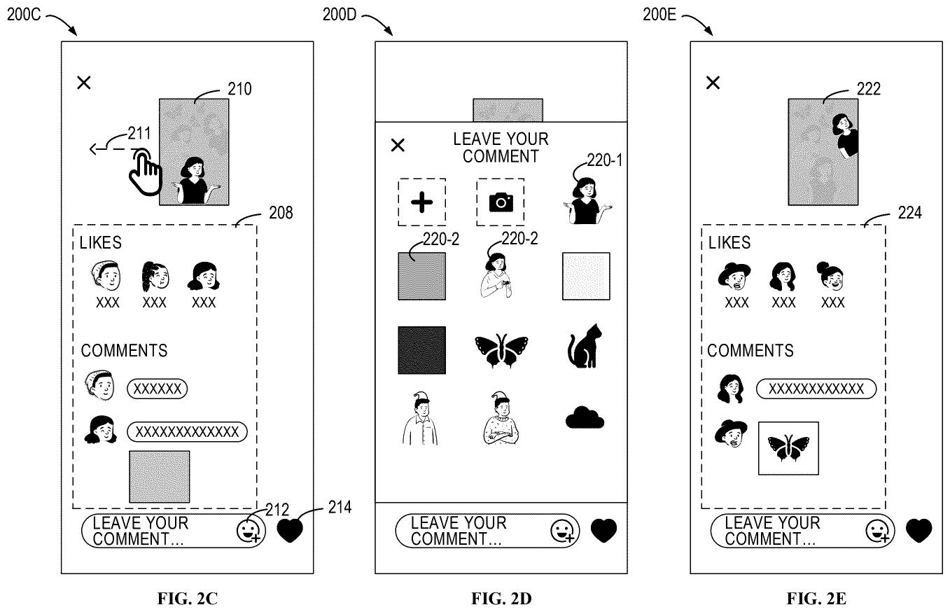

FIG. 3 illustrates a flowchart of an example process 300 of information interaction according to some embodiments in the present disclosure. The process 300 may be implemented at an electronic device 110. The process 300 is described below with reference to FIG. 1.

As shown in FIG. 3, at block 310, the electronic device 110 presents a viewing interface of target media content, the target media content including a set of foreground elements overlaid on a background image.

At block 320, the electronic device 110 presents, in response to a first operation on a first element in the set of foreground elements, a first interactive interface associated with the first element, the first interactive interface being configured to: present a first set of interaction information associated with the first element

In some embodiments, the first interactive interface is further configured to: receive an interactive operation associated with the first element.

In some embodiments, the set of foreground elements is associated with a plurality of creators, the process 300 further includes: in response to receiving a second operation on the first element in the viewing interface, presenting, in the viewing interface, descriptive information of a creator corresponding to the first element.

In some embodiments, the process 300 further includes: in response to the second operation, adjusting, in the viewing interface, a display style of the first element or other elements in the set of foreground elements, such that a display priority of the first element is higher than those of other elements.

In some embodiments, the interactive operation associated with the first element includes a sharing operation, and the process 300 further includes: in response to receiving the sharing operation associated with the first element, sending first content associated with the first element to a target user to be shared with.

In some embodiments, the interactive operation associated with the first element includes a collecting operation, and the process 300 further includes: in response to receiving the collection operation associated with the first element, adding the first element to a set of resources associated with a current user.

In some embodiments, receiving the interactive operation associated with the first element includes: providing a set of interactive controls in the first interactive interface; and receiving the interactive operation associated with the first element via the set of interactive controls.

In some embodiments, the set of interactive controls includes at least one of the following: a comment control; a like control; a collecting control; and a sharing control.

In some embodiments, the first interactive interface further presents a first thumbnail of the first element, and the process 300 further includes: in response to a predetermined operation associated with the first thumbnail, presenting a second interactive interface associated with a second element in the set of foreground elements, the second interactive interface presenting a second thumbnail of the second element, and the second interactive interface is configured to: present a second set of interaction information associated with the second element, and/or receive an interactive operation associated with the second element.

In some embodiments, the target media content is associated with a third set of interaction information independent of the first set of interaction information.

In some embodiments, the process 300 further includes, in response to receiving the interactive operation associated with the first element, sending a prompt message associated with the interactive operation to a first user associated with the first element and/or a second user associated with the target media content.

In some embodiments, the process 300 further includes: presenting, in the viewing interface, a set of outline elements indicating boundaries of the set of foreground elements.

### Example Apparatus and Apparatus

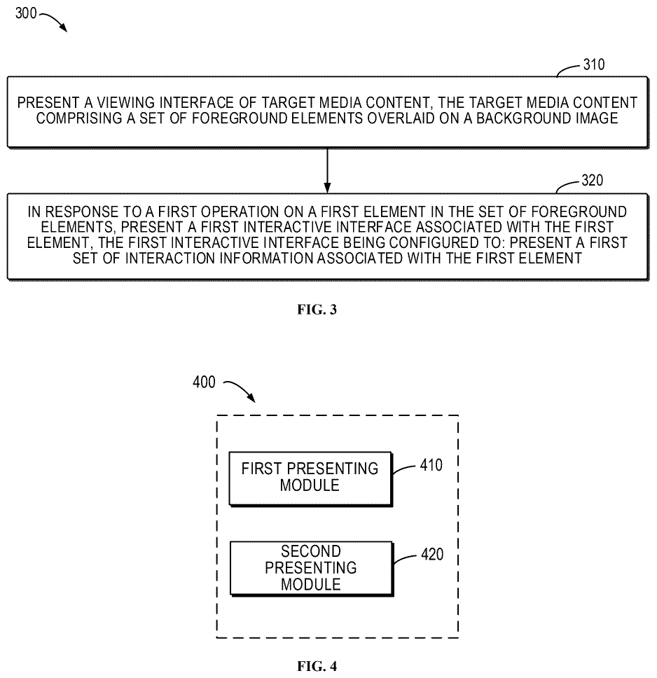

Embodiments in the present disclosure also provide a corresponding apparatus for performing the above method or process. FIG. 4 shows a schematic structural block diagram of an example apparatus 400 for information interaction according to some embodiments in the present disclosure. The apparatus 400 may be implemented or included in an electronic device. The various modules/components in the apparatus 400 may be implemented by hardware, software, firmware, or any combination thereof.

As shown in FIG. 4, the apparatus 400 includes a first presenting module, configured to present a viewing interface of target media content, the target media content including a set of foreground elements overlaid on a background image; and a second presenting module, configured to present, in response to a first operation on a first element in the set of foreground elements, a first interactive interface associated with the first element, the first interactive interface being configured to: present a first set of interaction information associated with the first element.

In some embodiments, the first interactive interface is further configured to: receive an interactive operation associated with the first element.

In some embodiments, the set of foreground elements is associated with a plurality of creators, and the apparatus 400 further includes an information module configured to: in response to receiving a second operation on the first element in the viewing interface, presenting, in the viewing interface, descriptive information of a creator corresponding to the first element.

In some embodiments, the apparatus 400 further includes a style module configured to: in response to the second operation, adjusting, in the viewing interface, a display style of the first element or other elements in the set of foreground elements, such that a display priority of the first element is higher than those of other elements.

In some embodiments, the interactive operation associated with the first element includes a sharing operation, the apparatus 400 further includes a sharing module configured to: in response to receiving the sharing operation associated with the first element, sending first content associated with the first element to a target user to be shared with.

In some embodiments, the interactive operation associated with the first element includes a collecting operation, the apparatus 400 further includes a collecting module configured to: in response to receiving the collection operation associated with the first element, adding the first element to a set of resources associated with a current user.

In some embodiments, the second presenting module 420 is further configured to: providing a set of interactive controls in the first interactive interface; and receiving the interactive operation associated with the first element via the set of interactive controls.

In some embodiments, the set of interactive controls includes at least one of the following: a comment control; a like control; a collecting control; and a sharing control.

In some embodiments, the first interactive interface further presents a first thumbnail of the first element, and the apparatus 400 further includes a third presenting module configured to: in response to a predetermined operation associated with the first thumbnail, presenting a second interactive interface associated with a second element in the set of foreground elements, the second interactive interface presenting a second thumbnail of the second element, and the second interactive interface is configured to: present a second set of interaction information associated with the second element, and/or receive an interactive operation associated with the second element.

In some embodiments, the target media content is associated with a third set of interaction information independent of the first set of interaction information.

In some embodiments, the apparatus 400 further includes a sending module configured to: in response to receiving the interactive operation associated with the first element, sending a prompt message associated with the interactive operation to a first user associated with the first element and/or a second user associated with the target media content.

In some embodiments, the apparatus 400 further includes an element module configured to: presenting, in the viewing interface, a set of outline elements indicating boundaries of the set of foreground elements.

The modules included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example and not limitation, example types of hardware logic components that may be used include field programmable gate arrays (FPGAs), application specific integrated circuits (ASICs), application specific standards products (ASSPs), system-on-a-chip (SOCs), complex programmable logic devices (CPLDs), and the like.

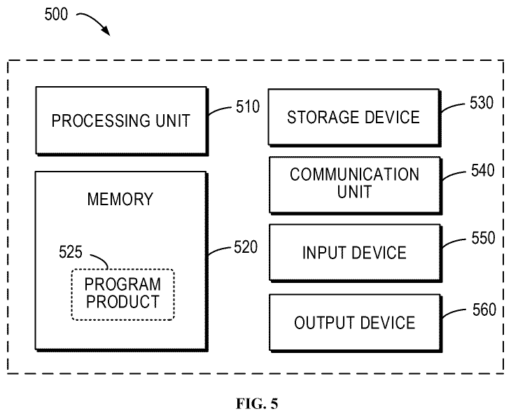

IG. 5 illustrates a block diagram of an electronic device 500 in which one or more embodiments in the present disclosure may be implemented. It would be appreciated that the electronic device 500 illustrated in FIG. 5 is merely exemplary and should not constitute any limitation on the functionality and scope of the embodiments described herein. The electronic device 500 shown in FIG. 5 may be used in an electronic device.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor capable of performing various processes according to a program stored in the memory 520. In a multiprocessor system, a plurality of processing units execute computer-executable instructions in parallel to improve the parallel processing capabilities of electronic device 500.

The electronic device 500 typically includes a variety of computer storage media. Such media may be any available media that are accessible to the electronic device 500, including, but not limited to, volatile and non-volatile media, removable and non-removable media. The memory 520 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium that can be used to store information and/or data and that can be accessed within the electronic device 500.

The electronic device 500 may further include an additional removable/non-removable, volatile/non-volatile storage medium. Although not shown in FIG. 5, a disk drive for reading from or writing to a removable, non-volatile magnetic disk (e.g., a “floppy disk”) or an optical disk drive for reading from or writing to a removable, non-volatile optical disk may be provided. In these cases, each drive may be connected to a bus (not shown) by one or more data media interfaces. The memory 520 may include a computer program product 525 having one or more program modules configured to execute various methods or actions of the various embodiments in the present disclosure.

The communication unit 540 is configured to communicate with other electronic devices through a communication medium. Additionally, the functionality of components of the electronic device 500 may be implemented by a single computing cluster or multiple computing machines capable of communicating through a communication connection. Thus, the electronic device 500 may operate in a networked environment using a logical connection with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed. The external device, such as a storage device, a display device, etc., communicates with one or more devices that enable users to interact with the electronic device 500, or communicates with any device (e.g., a network card, a modem, etc.) that enables the electronic device 500 to communicate with one or more other electronic devices.

Such communication may be performed via an input/output (I/O) interface (not shown).

According to example implementations in the present disclosure, a computer-readable storage medium having computer-executable instructions stored thereon is provided. The computer-executable instructions are executed by a processor to implement the method described above. According to example implementations in the present disclosure, a computer program product is further provided. The computer program product is tangibly stored on a non-transitory computer-readable medium and includes computer-executable instructions. The computer-executable instructions are executed by a processor to implement the method described above.

Various aspects in the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general-purpose computer, special computer, or other programmable data processing apparatus to produce a machine that generates an apparatus to implement the functions/acts specified in one or more blocks in the flowchart and/or the block diagram when these instructions are executed through the processing units of the computer or other programmable data processing devices. These computer-readable program instructions may also be stored in a computer-readable storage medium. These instructions cause the computer, programmable data processing apparatus, and/or other devices to work in a specific way. Therefore, the computer-readable medium storing instructions includes an article of manufacture including instructions to implement aspects of the functions/acts specified in one or more blocks in the flowchart and/or block diagram(s).

The computer-readable program instructions may be loaded onto a computer, a programmable data processing apparatus, or a further device, such that a series of operational steps can be performed on the computer, programmable data processing apparatus, or the further device to produce a computer-implemented process. As such, the instructions executed on the computer, programmable data processing apparatus, or the further device implement the functions/acts specified in the one or more blocks in the flowchart and/or block diagram(s).

The flowchart and block diagrams in the drawings show the possible architecture, functions and operations of the system, the method, and the computer program product implemented according to various implementations in the present disclosure. In this regard, each block in the flowchart or block diagram may represent a part of a module, a program segment or instructions, which contains one or more executable instructions for implementing the specified logic function(s). In some alternative implementations, the functions marked in the blocks may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by a combination of a dedicated hardware and computer instructions.

Various implementations in the present disclosure have been described above. The above description is exemplary, not exhaustive, and the present application is not limited to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the implementations disclosed herein.

I/We claim:

1. A method for information interaction, comprising:
presenting a viewing interface of target media content, the target media content comprising a set of foreground elements overlaid on a background image; and
in response to a first operation on a first element in the set of foreground elements, presenting a first interactive interface associated with the first element, the first interactive interface being configured to: present a first set of interaction information associated with the first element.

2. The method of claim 1, the first interactive interface is further configured to:
receive an interactive operation associated with the first element.

3. The method of claim 1, wherein the set of foreground elements is associated with a plurality of creators, the method further comprises:
in response to receiving a second operation on the first element in the viewing interface, presenting, in the viewing interface, descriptive information of a creator corresponding to the first element.

4. The method of claim 3, further comprising:
in response to the second operation, adjusting, in the viewing interface, a display style of the first element or other elements in the set of foreground elements, such that a display priority of the first element is higher than those of other elements.

5. The method of claim 2, wherein the interactive operation associated with the first element comprises a sharing operation, the method further comprises:
in response to receiving the sharing operation associated with the first element, sending first content associated with the first element to a target user to be shared with.

6. The method of claim 2, wherein the interactive operation associated with the first element comprises a collecting operation, the method further comprises:
in response to receiving the collecting operation associated with the first element, adding the first element to a set of resources associated with a current user.

7. The method of claim 2, wherein receiving the interactive operation associated with the first element comprises:
providing a set of interactive controls in the first interactive interface; and
receiving the interactive operation associated with the first element via the set of interactive controls.

8. The method of claim 7, wherein the set of interactive controls comprises at least one of:
a comment control;
a like control;
a collection control;
a sharing control.

9. The method of claim 1, wherein the first interactive interface further presents a first thumbnail of the first element, and the method further comprises:
in response to a predetermined operation associated with the first thumbnail, presenting a second interactive interface associated with a second element in the set of foreground elements, the second interactive interface presenting a second thumbnail of the second element, and the second interactive interface is configured to: present a second set of interaction information associated with the second element, and/or receive an interactive operation associated with the second element.

10. The method of claim 1, wherein the target media content is associated with a third set of interaction information independent of the first set of interaction information.

11. The method of claim 2, further comprising:
in response to receiving the interactive operation associated with the first element, sending a prompt message associated with the interactive operation to a first user associated with the first element and/or a second user associated with the target media content.

12. The method of claim 1, further comprising:
presenting, in the viewing interface, a set of outline elements indicating boundaries of the set of foreground elements.

13. An electronic device, comprising:
at least one processing unit; and
at least one memory coupled to the at least one processing unit and storing instructions executed by the at least one processing unit, the instructions, when executed by the at least one processing unit, causing the electronic device to perform acts comprising:
presenting a viewing interface of target media content, the target media content comprising a set of foreground elements overlaid on a background image; and
in response to a first operation on a first element in the set of foreground elements, presenting a first interactive interface associated with the first element, the first interactive interface being configured to: present a first set of interaction information associated with the first element.

14. The electronic device of claim 13, the first interactive interface is further configured to:
receive an interactive operation associated with the first element.

15. The electronic device of claim 13, wherein the set of foreground elements is associated with a plurality of creators, the acts further comprise:
in response to receiving a second operation on the first element in the viewing interface, presenting, in the viewing interface, descriptive information of a creator corresponding to the first element.

16. The electronic device of claim 15, the acts further comprising:
in response to the second operation, adjusting, in the viewing interface, a display style of the first element or other elements in the set of foreground elements, such that a display priority of the first element is higher than those of other elements.

17. The electronic device of claim 14, wherein the interactive operation associated with the first element comprises a sharing operation, the acts further comprise:
in response to receiving the sharing operation associated with the first element, sending first content associated with the first element to a target user to be shared with.

18. The electronic device of claim 14, wherein the interactive operation associated with the first element comprises a collecting operation, the acts further comprise:
in response to receiving the collecting operation associated with the first element, adding the first element to a set of resources associated with a current user.

19. The electronic device of claim 14, wherein receiving the interactive operation associated with the first element comprises:
providing a set of interactive controls in the first interactive interface; and
receiving the interactive operation associated with the first element via the set of interactive controls.

20. A non-transitory computer-readable storage medium having stored thereon a computer program which, executable by a processor to perform acts comprising:
presenting a viewing interface of target media content, the target media content comprising a set of foreground elements overlaid on a background image; and
in response to a first operation on a first element in the set of foreground elements, presenting a first interactive interface associated with the first element, the first interactive interface being configured to: present a first set of interaction information associated with the first element.
